(19) United States
(12) Patent Application Publication
(10) Pub. No.: US 2025/0307131 A1
(43) Pub. Date: Oct. 2, 2025

(54) VIDEO GAME TESTING AND GAMEPLAY FEEDBACK USING EYE TRACKING

(71) Applicant: Electronic Arts Inc., Redwood City, CA (US)

(72) Inventor: William Arthur Gordon, Apopka, FL (US)

(21) Appl. No.: 18/622,043

(22) Filed: Mar. 29, 2024

(51) Int. Cl. G06F 11/36; A63F 13/77; G06F 3/01

(52) U.S. Cl. CPC G06F 11/3698; A63F 13/77; G06F 3/013

(57) ABSTRACT

A device may as implemented by an interactive computing system configured with specific computer-executable instructions, capturing one or more image frames of a video game, receiving, from one or more sensors, eye tracking information associated with a user playing the video game, associating the eye tracking information with the one or more image frames, identifying at least a first frame based at least in part on the eye tracking information, identifying at least one feature of interest within the first frame based on the eye tracking information, and outputting an indication associated with the at least one feature of interest.

### BACKGROUND

Software developers typically desire for their software to engage users and run without errors. However, as the complexity of the software increases, it can be difficult to determine user engagement and to find and eliminate errors within the software. This is particularly true with respect to video games. The complexity of video game software can make it difficult to determine when and where errors occur in the software. Further, the subjective nature of engagement can make it difficult to determine engaging features of a video game.

### SUMMARY OF EMBODIMENTS

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

In some aspects, the techniques described herein relate to a computer-implemented method including: as implemented by an interactive computing system configured with specific computer-executable instructions, capturing one or more image frames of a video game; receiving, from one or more sensors, eye tracking information associated with a user playing the video game; associating the eye tracking information with the one or more image frames; identifying at least a first frame based at least in part on the eye tracking information; identifying at least one feature of interest within the first frame based on the eye tracking information; and outputting an indication associated with the at least one feature of interest.

In some aspects, the techniques described herein relate to a computer-implemented method, wherein the indication is a category associated the at least one feature of interest. In some aspects, the techniques described herein relate to a computer-implemented method, the category is a rendering error for an improperly rendered or an unrendered feature. In some aspects, the techniques described herein relate to a computer-implemented method, wherein the one or more sensors include a camera. In some aspects, the techniques described herein relate to a computer-implemented method, wherein the sensor information includes positional information associated with the user. In some aspects, the techniques described herein relate to a computer-implemented method, wherein the one or more sensors includes a light detection and ranging (“LIDAR”) system. In some aspects, the techniques described herein relate to a computer-implemented method, wherein associating the sensor information with the one or more image frames include: generating at least a first heatmap based on the eye tracking information using one or more machine learning models trained to generate heatmaps from the eye tracking information; and associating the first heatmap with the one or more image frames. In some aspects, the techniques described herein relate to a computer-implemented method, wherein the first heatmap identifies eye position of the user with respect to image frames over a defined time frame. In some aspects, the techniques described herein relate to a computer-implemented method, further including altering a configuration of the video game based on the at least one feature of interest. In some aspects, the techniques described herein relate to a computer-implemented method, wherein altering the configuration of the video game includes: determining the first feature of interest triggers a condition; and causing one or more actions to occur in the video game based on the condition. In some aspects, the techniques described herein relate to a computer-implemented method, wherein the one or more actions include an animation triggered within a virtual environment of the video game.

In some aspects, the techniques described herein relate to a system including: one or more sensors; and one or more hardware processor in communication with the one or more sensors, the one or more hardware processors configured to execute specific computer-executable instructions to at least: capture one or more image frames of a video game; receive, from the one or more sensors, eye tracking information associated with a user playing the video game; associate the sensor information with the one or more image frames; identify at least a first frame based at least in part on the eye tracking information; identify at least one feature of interest within the first frame based on the eye tracking information; and output an indication associated with the at least one feature of interest.

In some aspects, the techniques described herein relate to a system, wherein the indication is a category associated the at least one feature of interest. In some aspects, the techniques described herein relate to a system, wherein the category is a rendering error for an improperly rendered or an unrendered feature. In some aspects, the techniques described herein relate to a system, wherein the one or more sensors include a camera. In some aspects, the techniques described herein relate to a system, wherein the one or more sensors include a light detection and ranging (“LIDAR”) system. In some aspects, the techniques described herein relate to a system, wherein to associate the sensor information with the one or more image frames, the one or more hardware processors are configured to execute the specific computer-executable instructions to: generate at least a first heatmap based on the eye tracking information using one or more machine learning models trained to generate heatmaps from the eye tracking information; and associate the first heatmap with the one or more image frames. In some aspects, the techniques described herein relate to a system, wherein the first heatmap identifies eye position of the user with respect to image frames over a defined time frame. In some aspects, the techniques described herein relate to a system, wherein the one or more hardware processors are further configured to execute the specific computer-executable instructions to alter a configuration of the video game based on the first frame of interest.

In some aspects, the techniques described herein relate to a non-transitory computer-readable storage medium storing computer executable instructions that, when executed by one or more computing devices, configure the one or more computing devices to perform operations including: as implemented by an interactive computing system configured with specific computer-executable instructions, capturing one or more image frames of a video game; receiving, from one or more sensors, eye tracking information associated with a user playing the video game; associating the eye tracking information with the one or more image frames; identifying at least a first frame based at least in part on the eye tracking information; identifying at least one feature of interest within the first frame based on the eye tracking information; and outputting an indication associated with the at least one feature of interest.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1 illustrates an embodiment of a networked computing environment that can implement one or more embodiments of a game test engine and a game configuration system.

FIG. 2 illustrates an embodiment of an image and sensor analysis engine.

FIG. 3A-C illustrates an example of an association between an image frame of a video game and a generated heatmap.

FIG. 4 presents a flowchart of an embodiment of a video game testing process using eye tracking information.

FIG. 5 presents a flowchart of an embodiment of a video game testing process of identifying frames and/or features of interest in a video game.

FIG. 6 presents a flowchart of an embodiment of a video game testing process of associating testing information with game configurations.

FIG. 7 presents a flowchart of an embodiment of a video game testing process using user position information.

FIG. 8 presents a flowchart of an embodiment of a video game configuration process using eye tracking information.

FIG. 9 illustrates an embodiment of a user computing system.

FIG. 10 illustrates an embodiment of a hardware configuration a the user computing system.

### DETAILED DESCRIPTION OF EMBODIMENTS

### Introduction

Users can interact with video games in various ways. Traditionally, only a portion of a user's interactions are captured by the video game or a computing system. For example, a user may use a controller, or other input device, to interact with the video game. In this example, much of the user interactions are not captured, such as certain responses by the user based on stimulus provided by the video game to the user.

One response a user can have to a video game is eye movement. A video game display is often agnostic to eye position. For example, the video game display is the same regardless of where a user is looking. Another response a user can have to a video game is position of the user relative to a video game display. The video game display is also generally agnostic to user position relative to the video game display. Because such user responses are not captured, the information is lost and cannot be used as input into the video game or a computing system.

Systems disclosed herein can capture user responses to a video game for use as input into the video game and for use in testing video games. When used as input to the video game, the user responses can be used to modify a configuration of the video game based on the user responses. For example, the video game can be modified based on where a user is looking and/or based on a position of the user.

When used for testing, the user responses can be used to by video game testing systems to analyze runtime data of the game application. For example, eye tracking information and/or user positional information can be used to find interesting features of the video game, find errors in the video game, inform a determination of a user's emotional state while playing the video game, and/or compare responses to multiple versions of a video game, to list a few.

Systems disclosed herein can include sensors, such as capturing systems (such as cameras), wearable devices, position detecting systems (such as light detection and ranging (“LIDAR”) systems), and the like to capture user responses to a video game. The systems can associate runtime data from a gameplay session of a video game (such as an image frame or sets of images frames) with the user responses. The testing system can aggregate and track these associations for use in testing the video game. The testing system can also use the associations as input to the video game.

In some implementations, systems disclosed herein, such as an image and sensor analysis engine, can associate eye tracking and positional information with image frames to find features of the video game that are holding the user's attention (e.g., the user looks at the features for a period of time or positions closer to the screen when the features are presented). In these implementations, the features can be examined, for example by one or more machine learning models, to determine attributes of the features, such as whether the feature represents an error. The features can also be examined and used to alter a state or configuration of the video game. For example, a user looking at a particular feature may trigger a game condition. Advantageously, the systems may better capture and utilize user interactions for better testing of video games, and increased configurability and responsiveness of video games.

To simplify discussion, the present disclosure is primarily described with respect to a video game. However, the present disclosure is not limited as such may be applied to other types of applications. For example, embodiments disclosed herein may be applied to educational applications or other applications that may be modified based on a history of user interactivity with the application. Further, the present disclosure is not limited with respect to the type of video game. The use of the term “video game” herein includes all types of electronic games, including, but not limited to web-based games, console games, personal computer (PC) games, computer games, games for mobile devices (for example, smartphones, portable consoles, gaming machines, or wearable devices, such as virtual reality glasses, augmented reality glasses, or smart watches), or virtual reality games, as well as other types of electronic games.

### Example Networked Computing Environment

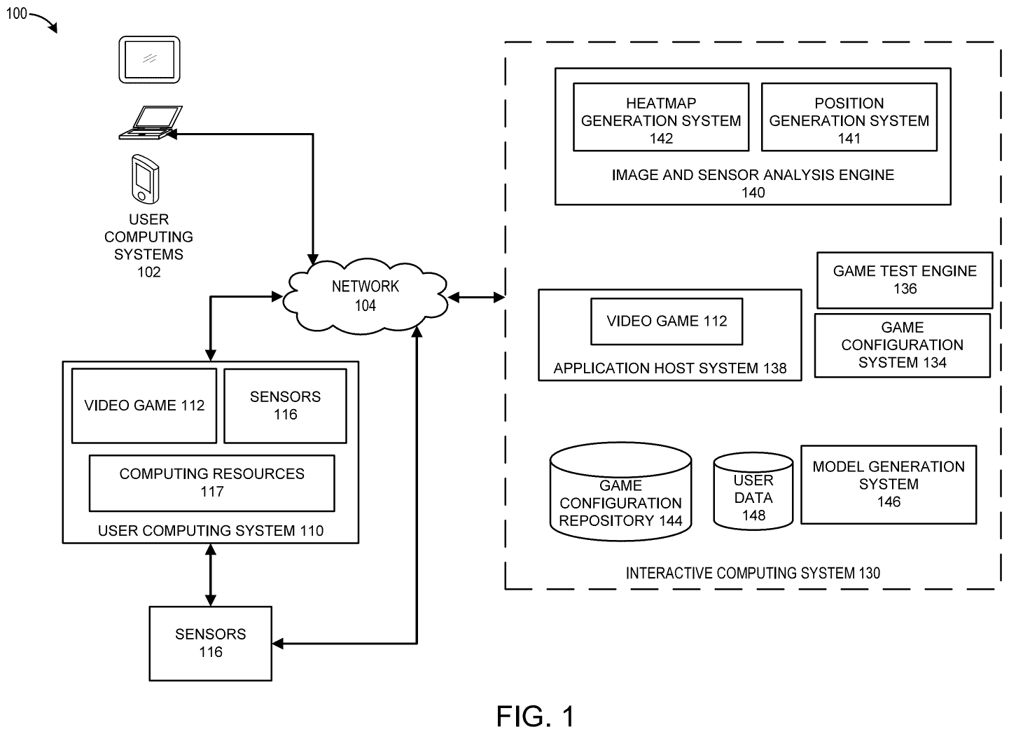

FIG. 1 illustrates an embodiment of a networked computing environment 100 that can implement one or more embodiments of a game test engine 136 and/or a game configuration system 134. The networked computing environment 100 includes a user computing system 110 that can communicate with an interactive computing system 130 via a network 104. Further, the networked computing environment 100 may include a number of additional user computing systems 102. At least some of the user computing systems 102 may be configured the same as or similar to the user computing system 110.

### Video Game

User computing system 110 may include and/or host a video game 112. In some cases, the video game 112 may execute entirely on the user computing system 110. In other cases, the video game 112 may execute at least partially on the user computing system 110 and at least partially on the interactive computing system 130. In some cases, the video game 112 may execute entirely on the interactive computing system 130, but a user may interact with the video game 112 via the user computing system 110. For example, the game may be an online game that includes a client portion executed by the user computing system 110 and a server portion executed by one or more application host systems 138 that may be included as part of the interactive computing system 130. As another example, the video game 112 may be an adventure game played on the user computing system 110 without interacting with the interactive computing system 130.

### Sensors

The user computing system 110 may further include or be electronically connected to a set of sensors 116 that obtain information associated with a user playing the video game 112. In some embodiments, the sensors 116 generate signals that are provided to the interactive computing system 130, which can convert the signals to the information associated with the user playing the video game data. The sensors 116 may provide information associated with where the user playing the video game 112 is looking (referred to herein as eye tracking information). The sensors 116 may provide information associated with a position of the user playing the video game 112 (referred to herein as user position information).

The sensors 116 can include any type of system or sensor that can capture sensory data relating to a user. For example, the sensors 116 may include image capturing systems (such as cameras), wearable devices, position detecting systems (such as LIDAR systems), and the like. In some embodiments, all or a portion of the sensors 116 may be incorporated in the user computing system 110, such as a camera or microphone. Alternatively, or in addition, all or a portion of the sensors 116 may be an accessory for the user computing system 110, such as a gamepad that includes sensors or a camera accessory.

In certain embodiments, as illustrated in FIG. 1, all or a portion of the sensors 116 may be separate from the user computing system 110. In some cases, the sensors 116 may communicate with the user computing system 110. Alternatively, or in addition, the sensors 116 may communication with the interactive computing system 130 via the network 104. For example, the sensor may be a camera that can record saliency information. The camera may communicate with the user computing system 110 and/or with the interactive computing system 130.

### Computing Resources

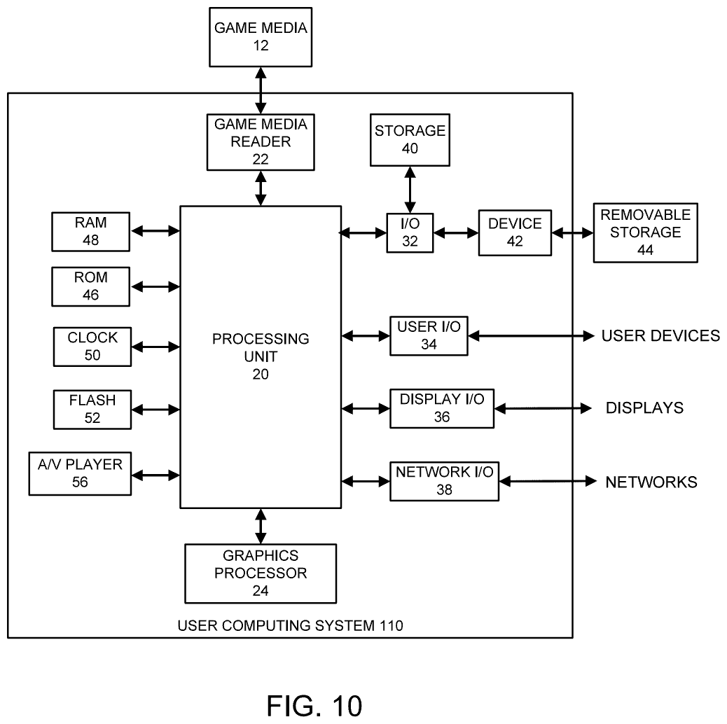

The user computing system 110 may have various computing resources 117. The computing resources 117 may include hardware and software components for establishing communications over a communication network 104. For example, the user computing system 110 may be equipped with networking equipment and network software applications (for example, a web browser) that facilitate communications via a network (for example, the Internet) or an intranet. The computing resources 117 may include varied local computing resources, such as central processing units and architectures, memory, mass storage, graphics processing units, communication network availability and bandwidth, and so forth. Further, the computing resources 117 may include any type of computing system. For example, the user computing system 110 may include any type of computing device(s), such as desktops, laptops, video game platforms, television set-top boxes, televisions (for example, Internet TVs), network-enabled kiosks, car-console devices, computerized appliances, wearable devices (for example, smart watches and glasses with computing functionality), and wireless mobile devices (for example, smart phones, PDAs, tablets, or the like), to name a few. In some embodiments, the user computing system 110 may include one or more of the embodiments described below with respect to FIGS. 10 and 11.

### Interactive Computing System

It may be desirable to track and utilize information associated with a user of the video game 112 for testing the video game 112. For example, eye tracking information may be used to identify features of the video game 112 users tend to look at. As such, eye tracking information may provide helpful information in video game development, such as if users are looking where the developers expect, if an anomaly and/or undesirable feature (e.g., an unrendered or wrongly rendered virtual object) appears in the video game 112. It may also be desirable to track and utilize information associated with a user of the video game 112 for use within, and/or as an input to, the video game 112. For example, eye tracking information may be utilized by the video game to trigger conditions within the video game 112 and/or otherwise alter the video game 112 (e.g., cause an animation to occur where someone is looking, center the virtual frame based on eye position, etc.)

The interactive computing system 130 may include a number of systems or subsystems for facilitating tracking and for utilizing information associated with a user of the video game 112. These systems and/or subsystems can include an image and sensor analysis engine 140, a game configuration system 134, a game test engine 136, an application host system 138, a heatmap generation system 142, a position generation system 141, and a model generation system 146. Further, the interactive computing system 130 may include one or more repositories for storing data used to facilitate performing the processes described herein. These repositories may include a user data repository 148 and a game configuration repository 144. It should be understood that the interactive computing system 130 may include more or fewer repositories for the optimal storage and management of data used with the processes described herein.

Each of the aforementioned systems of the interactive computing system 130 may be implemented in hardware, and software, or a combination of hardware and software. Further, each of the systems may be implemented in a single computing system comprising computer hardware or in one or more separate or distributed computing systems. Moreover, while the systems are shown in FIG. 1 to be stored or executed on the interactive computing system 130, it is recognized that in some embodiments, part or all of the systems can be stored and executed on the user computing system 110.

In some embodiments, when the user computing system 110 is connected or in communication with the interactive computing system 130 via the network 104, the interactive computing system 130 may perform the processes described herein. However, in some cases where the user computing system 110 and the interactive computing system 130 are not in communication, the user computing system 110 may perform certain processes described herein using the eye tracking information of the user that may be stored at the user computing system 110. In certain embodiments, one or more elements of the interactive computing system 130 may be combined or further separated among one or more computing systems.

### Image and Sensor Analysis Engine

The image and sensor analysis engine 140 may include any system that can use signals and/or data obtained from the sensors 116 to determine or predict eye tracking information (e.g., heatmaps) and positional information associated with a user of the video game 112. In some embodiments, the image and sensor analysis engine 140 may obtain and/or aggregate sensory data to determine or predict the eye tracking and positional information of the user playing the video game 112. The image and sensor analysis engine 140 may obtain image frames from the video game 112. The image and sensor analysis engine 140 may associate the image frames with eye tracking and positional information of a user playing the video game 112 to extract features of the video game 112 that are interesting to the user.

In some embodiments, the image and sensor analysis engine 140 may include a number of subsystems to facilitate obtaining or extracting sensor data from signals received from the sensors 116 and for capturing image frames of the video game 112. Further, at least some of the number of subsystems may perform analysis of the sensor data and image frames and/or may aggregate or collate some of the sensor data and image frames. The result of the analysis and/or the aggregated sensor data and image frames may be utilized by the image and sensor analysis engine 140 to determine or predict the eye tracking and positional information of the user playing the video game 112 by using, for example, one or more parameter or prediction functions generated using a machine learning process. Such parameters or prediction functions may be utilized by the game configuration system 134 to determine one or more aspects of a configuration or a state of the video game 112 to modify based on the sensor data and/or to by the game test engine 136 to determine features of interest for a user.

### Heatmap Generation System

The image and sensor analysis engine 140 may include a heatmap generation system 142 to generate heatmaps associated with a user of the video game 112. A heatmap may be a coordinate representation of a display associated with eye tracking information. Each coordinate on a heatmap may be associated with a value. Each coordinate value may be based in part on a length of time a user's eye is looking at and/or around the coordinate. Each coordinate value may also be based in part on a probability a user's eye would look at and/or around the coordinate. For example, the coordinate values may be based in part on predicted saliency information output from one or more machine learning models.

The heatmap generation system 142 may generate heatmaps based on sensor information received from sensors 116 and/or from predicted saliency information. As used herein, predicted saliency information is predicted eye tracking data based on an image. For example, predicted saliency image can indicate where a user is likely to look based on a provided image or captured image. The predicted saliency information may be previously generated and retrieved from stored memory (e.g., from the user data repository 148) or generated by the heatmap generation system 142 or other system (such as the image and sensor analysis engine 140). The heatmap generation system 142 can include one or more models, such as models from the model generation system 146, to generate the heatmaps and/or predicted saliency information.

The heatmap generation system 142 can receive sensor information from the sensors 116 and determine eye tracking information. For example, the heatmap generation system 142 can receive an image of a user from a camera and determine a coordinate or set of coordinates the user is looking at on a display. The heatmap generation system 142 can use the eye tracking information to determine a duration of time the user is looking at a coordinate or set of coordinates to generate the coordinate values of a heatmap.

In some instances, the heatmap generation system 142 may use one or more models to filter some information in the eye tracking information. For example, user may tend to look toward the center of a display, regardless of features present in the center of the display. In this example, the heatmap generation system 142 may utilize one or more image saliency models to filter out some of the instances where the user is looking at the center of the display (for example, an image saliency model may indicate that no salient feature is present in the center of the display at the time).

### Position Generations System

The image and sensor analysis engine 140 may include a position generation system 141 to generate user position information associated with a user of the video game 112. User position information may be representative of a physical position associated with a user of the video game 112, relative to a display. For example, the user position information may include a distance the user is from the display. The user position information may be based on information received from the sensors 116. For example, the sensors 116 and/or the position generation system 141 may include a light detection and ranging (“LIDAR”) system that can calculate the distance of the user from the sensors 116. In this example, the position generation system 141 can use the distance calculation from the LIDAR system to determine the distance between the user and the display. The position generation system 141 may include one or more models and/or other systems to generate the user position information.

### Game Configuration System

The game configuration system 134 sets or adjusts the state or configuration of a video game 112. In some embodiments, the game configuration system 134 modifies an existing configuration of the video game 112. Setting or modifying the configuration of the video game 112 may include modifying or changing one or more aspects of the video game 112 during runtime. Examples of modifying or changing aspects of the video game 112 can include adjusting a difficulty level, initiating an animation, prompting a visual indicator, adjusting the amount of light or the color of the shaders or textures, or adjusting a point of view location, to list a few. However, the present disclosure is not limited to these examples. Instead, embodiments of the present disclosure can be used to set or modify various different aspects of video game 112.

In certain embodiments, the game configuration system 134 may adjust the gameplay experience of playing the video game 112 by modifying the sequence of stages within the game, items that are dropped during the game, the difficulty level of the game, non-playable characters (NPCs) that are encountered during the game, and any other features of the video game 112 that can result in a different gameplay experience of the user. In some embodiments, the game configuration system 134 may adjust the video game 112 by modifying seed values that are used to generate portions of the video game 112 or other aspects of the video game 112, such as item drop rates or enemy appearances.

### Model Generation System

The model generation system 146 can use one or more machine learning algorithms to generate one or more models for analyzing sensor data received from the sensors 116 and/or other information. One or more of these models may be used to determine an expected value or occurrence based on a set of inputs. For example, a prediction model can be used to determine predicted saliency information based on an image frame of the video game 112. In some cases, the model may be termed a prediction model because, for example, the output may be or may be related to a prediction of a state, such as where a user is likely to look for a give image frame. A number of different types of algorithms may be used by the model generation system 146. For example, certain embodiments herein may use a logistical regression algorithm. However, other algorithms are possible, such as a linear regression algorithm, a discrete choice algorithm, or a generalized linear algorithm.

The machine learning algorithms can be configured to adaptively develop and update the models over time based on new input received by the model generation system 146. For example, the models can be regenerated on a periodic basis as new user information (for example, additional sensor data) is available to help keep the predictions in the model more accurate as the user information evolves over time. After a model is generated, it can be provided to other systems or subsystems of the interactive computing system 130, such as the image and sensor analysis engine 140, the game test engine 136, the game configuration system 134, the heatmap generation system 142, and the position generation system 141.

### Game Test Engine

In certain embodiments, the systems disclosed herein can be used to test the video game 112. Testing the video game can include determining features within the video game that hold user attention, finding anomalies or undesirable features, and/or testing or experimenting on different versions of the video game 112, to list a few. The game test engine 136 can include any system that can perform testing of the video game 112 to determine the impact on changes to the video game 112. For example, the game test engine 136 may include one or more machine learning models, such as deep image saliency models, trained to analyze images and predict salience information and/or one or more machine learning models used to analyze heatmaps and extract features.

The game test engine 136 can be used to detect the existence of bugs or errors in the video game 112 through analyzing eye tracking information and/or user position information. Embodiments disclosed herein enable the game test engine 136 to determine the impact of different configurations of portions of the video game 112 on users playing the video game 112, by analyzing changes in eye tracking information and/or user position information in different game configurations. Thus, for example, the game test engine 136 may cause one version of the video game 112 to be presented to a first set of users, and another version of the video game 112 to be presented to a second set of users. The presentation of different versions of the video game 112 to different sets of users may be referred to as A/B testing.

The image and sensor analysis engine 140 can obtain sensor data from the different sets of users. The sensor data can be used to determine features of the video game 112 that generate responses in the eye tracking or position information associated with the different sets of users. Based on these responses, the game test engine 136 can determine versions of the video game 112 that are more likely to generate responses, such as response associated with a positive or negative user experience, in the eye tracking or position information compared to other versions of the video game 112.

### Game Configuration Repository

The game configuration repository 144 can include one or more mappings between the output of a model and a configuration or state of the video game 112, which may be used by, for example, the game configuration system 134 to determine how to modify the video game 112. For example, the game configuration repository 144 may store one or more animations that may trigger if the output of a model indicates a user has looked at a particular feature of the video game. As another example, the game configuration repository 144 may store a brightness mapping the game configuration system 134 may utilize based on the user's proximity to a display (e.g., decrease the brightness as the user gets closer to the display).

### User Data Repository

The user data repository 148 can store sensor data associated with one or more users' interaction with the video game 112 and/or one or more other video games. This sensor data can be obtained over one or more play sessions of the video game 112. In some cases, at least some of the data stored in the user data repository 148 may be stored at a repository of the user computing system 110. Each of the repositories described herein may include non-volatile memory or a combination of volatile and nonvolatile memory.

### Application Host System

As previously described, in some embodiments, the video game 112, or a portion thereof, may be hosted by an application host system 138 of the interactive computing system 130. For example, a MMORPG may have a portion executed or hosted on the user computing system 110 and a portion executed or hosted on an application host system 138 of the interactive computing system 130. In some such embodiments, the game configuration system 134 may modify the state of the video game 112 hosted at the user computing system 110 and/or the application host system 138.

### Network

The network 104 can include any type of communication network. For example, the network 104 can include one or more of a wide area network (WAN), a local area network (LAN), a cellular network, an ad hoc network, a satellite network, a wired network, a wireless network, and so forth. Further, in some cases, the network 104 can include the Internet.

### Example Image and Sensor Analysis Engine

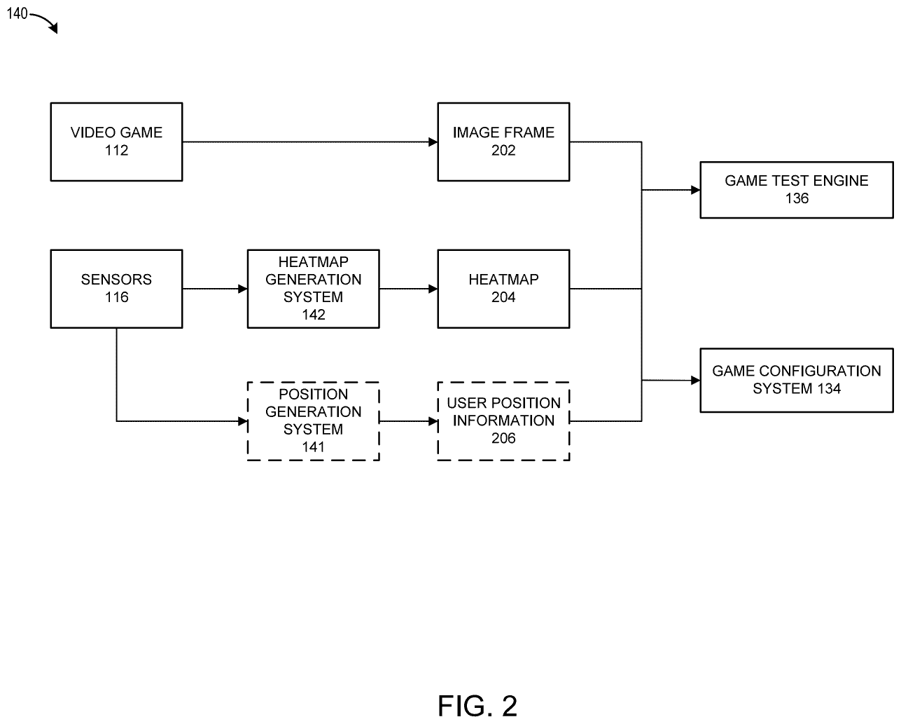

FIG. 2 illustrates an embodiment of an image and sensor analysis engine 140 of FIG. 1. The image and sensor analysis engine 140 can apply or use one or more of the models generated by the model generation system 146. Although illustrated as a separate system, in some cases, the image and sensor analysis engine 140 may be included as part of the game test engine 136 and/or the game configuration system 134.

During execution of a video game 112, the image and sensor analysis engine 140 may capture an image frame 202 of the video game 112. The image frame 202 can be an image of the video game at a particular instance during runtime. For example, the image frame 202 can be an image generated by the user computing system 110 and/or the interactive computing system 130 that is displayed to a user of the video game 112. The image and sensor analysis engine 140 may continuously capture image frames 202 during execution and runtime of the video game 112. For example, the image and sensor analysis engine 140 may capture an image frame 202 for every frame generated during runtime. In some instances, the image and sensor analysis engine 140 may capture image frames 202 at a fixed rate. The fixed rate may be the same as a rate at which frames of the video game 112 are generated or may be at a different rate (e.g., every other frame).

Each image frame 202 can have various features, such a virtual objects, textures, colors, shadows, and the like or any combination thereof. The features can share a degree of commonality between image frames 202. For example, a virtual object in an image frame 202 at an instance in time may also appear in an image frame 202 at the next instance in time. In this example, the virtual object in each image frame 202 may differ in some ways (e.g., the virtual object may be positioned differently in each image frame 202) and may be similar in other ways (e.g., the textures associated with the virtual object may render the same in each image frame 202).

The image and sensor analysis engine 140 may generate, for example, by using the heatmap generations system 142, and/or associate a heatmap 204 with each image frame 202. The amount of computing resources required to generate heatmaps 204 may be different than the amount of computing resources required to capture image frames 202. In some instances, the image and sensor analysis engine 140 may generate a different number of heatmaps 204 than captured image frames 202 to compensate for the differences in computing resources. For example, the image and sensor analysis engine 140 may generate fewer heatmaps 204 than captured image frames 202. In this example, the image and sensor analysis engine 140 may associate the same heatmap 204 with multiple image frames 202.

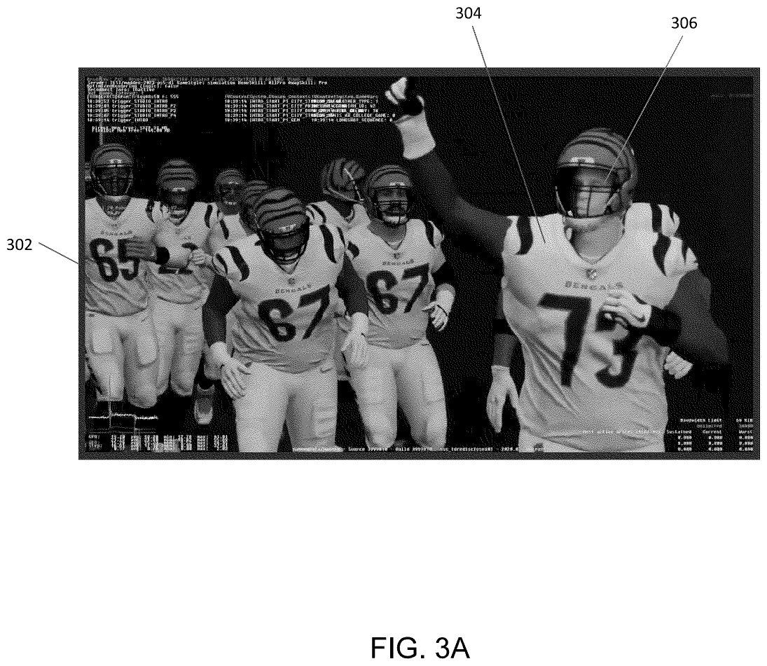

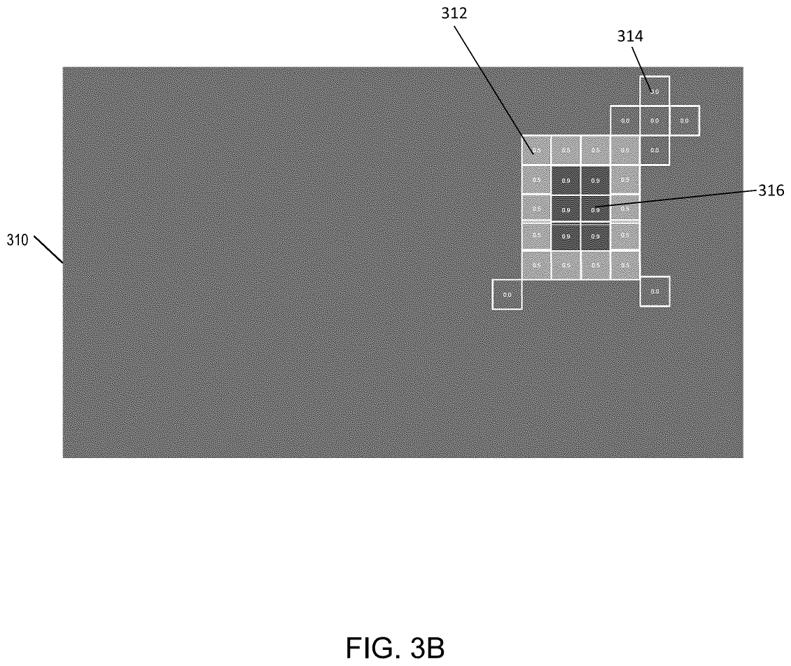

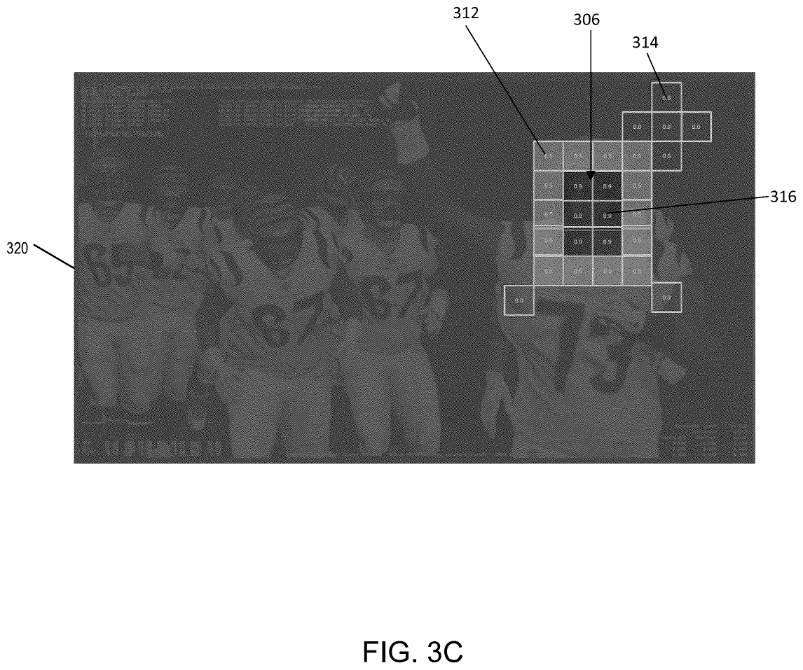

A heatmap 204 may be a coordinate representation of a display associated with eye tracking information. Each coordinate on a heatmap 204 may be associated with a value. Each coordinate value may be based in part on a length of time a user's eye is looking at and/or around the coordinate. Each coordinate value may also be based in part on a probability a user's eye would look at and/or around the coordinate. For example, the coordinate values may be based in part on predicted saliency information outputted from one or more machine learning models. Examples of heat maps 204 are illustrated in FIGS. 3B and 3C.

The image and sensor analysis engine 140 may generate the heatmaps 204 using the heatmap generation system 142 based on sensor information received from sensors 116 and/or from predicted saliency information. The predicted saliency information may be previously generated and retrieved from stored memory (e.g., from the user data repository 148) or generated by the heatmap generation system 142. The heatmap generation system 142 can include one or more models, such as models from the model generation system 146, to generate the heatmaps and/or predicted saliency information.

The heatmap generation system 142 can receive sensor information from the sensors 116 and determine eye tracking information. For example, the heatmap generation system 142 can receive an image of the user from a camera and determine a coordinate or set of coordinates the user is looking at on a display. The heatmap generation system 142 can use the eye tracking information to determine a duration of time the user is looking at a coordinate or set of coordinates to generate the coordinate values of a heatmap 204.

In some instances, the heatmap generation system 142 may use one or more models to filter the eye tracking information. For example, user may tend to look toward the center of a display, regardless of features present in the center of the display. In this example, the heatmap generation system 142 may utilize one or more image saliency models to filter out some of the instances where the user is looking at the center of the display (for example, an image saliency model may indicate that no salient feature is present in the center of the display at the time).

User position information 206 may be representative of a physical position associated with a user of the video game 112, relative to a display. For example, the user position information 206 may include a distance the user is from the display. The user position information 206 may be based on information received from the sensors 116. For example, the sensors 116 and/or the position generation system 141 may be a LIDAR system that can calculate the distance of the user from the sensors 116. In this example, the position generation system 141 can use the distance calculation from the LIDAR system to determine the distance between the user and the display. The position generation system 141 may include one or more models and/or other systems to generate the user position information 206.

The heatmaps 204 and/or the user position information 206 may include time stamp information relative to the execution of a video game 112. The image and sensor analysis engine 140 may associate the heatmaps 204 and/or user position information 206 with image frames based on the time stamp information. For example, the image and sensor analysis engine 140 may associate each heatmap 204 with the image frames 202 captured in a time frame indicated by the time stamp information. The image frames 202, heatmaps 204, and/or user position information 206 may be used by the game test engine 136, and/or the game configuration system 134.

### Example Image Frame and Heatmap Association

FIGS. 3A-3C illustrate one embodiment of the game test engine 136 utilizing a heatmap to detect a potentially undesirable feature. While an undesirable feature is illustrated in FIGS. 3A-3C, the game test engine 136 can utilize heatmaps in other ways. For example, the game test engine 136 may utilize heatmaps to identify features a user finds interesting. Further, heatmaps may be utilized by other systems, such as the game configuration system 134. In these instances, the heatmaps may trigger conditions in the game that alter game states.

FIG. 3A illustrates an example image frame 302. Image frame 302 can be an image frame 202 captured by the image and sensor analysis engine 140, as discussed in FIG. 2. Image frame 302 illustrates several features, including a character 304 with face 306. As is illustrated in in FIG. 3A, the face 306 may not render properly. For example, a texture package associated with the face 306 may render improperly or may not render. As such, face 306 may represent an undesirable feature for the game test engine 136 to detect.

FIG. 3B illustrates an example heatmap 310. Heatmap 310 can be a heatmap 204 generated by the heatmap generation system 142, as discussed in FIG. 2. Heatmap 310 can be associated with image frame 302 of FIG. 3A. Heatmap 310 includes various coordinates, such as coordinate 312, coordinate 314, and coordinate 316. Each coordinate includes a value. For example, coordinate 314 is illustrated as having a value of 0.0 and coordinate 316 is illustrated as having a value of 0.9. In the illustrated example, a high value is associated with a longer period of time a user looked at the coordinate and/or a higher probability that a user would look at the coordinate. Accordingly, heatmap 310 illustrates a user mostly looked around coordinate 316 for the time captured and/or is more likely to look at the area around coordinate 316.

FIG. 3C illustrates an example image 320. Image 320 depicts the heatmap 310 overlayed on the associated image frame 302. As is illustrated by image 320, the areas with the highest values, such as coordinate 316, correspond to the face 306. Similarly, the areas with intermediate values, such as coordinate 312, correspond to areas surrounding the face 306. As such, image 320 illustrates that a user looked mostly at the face 306 associated with an improperly rendered texture package.

Image 320 can be used by the game test engine 136 to detect an undesirable feature. For example, the game test engine 136 may analyze image 320, along with a large number of other images of the video game 112, and determine that the user was looking at an unexpected or unlikely feature, such as face 306. In this example, the game test engine 136 may further determine a rendering bug is present in image 112 by further analyzing image frame 302 and/or image 320 and determining face 306 has not rendered properly. The game test engine 136 may save image frame 302, heatmap 310, and/or image 320 for later reference or further analysis.

While the above references the use of the image frame 302, heatmap 310, and image 320 by the game test engine 136, the game configuration system 134 may also utilize the image frame 302, heatmap 310, and image 320. In some instances, image 320 can be used by the game configuration system 134 to alter a game state based on an association between one or more heatmaps, such as heatmap 310, and features, such as face 306. For example, a set of heatmaps, including heatmap 310, may indicate a user has looked at face 306 for longer than a threshold amount of time. In this example, the game configuration system 134 may trigger a condition, such as an animation for the face 306.

### Example Video Game Testing Processes

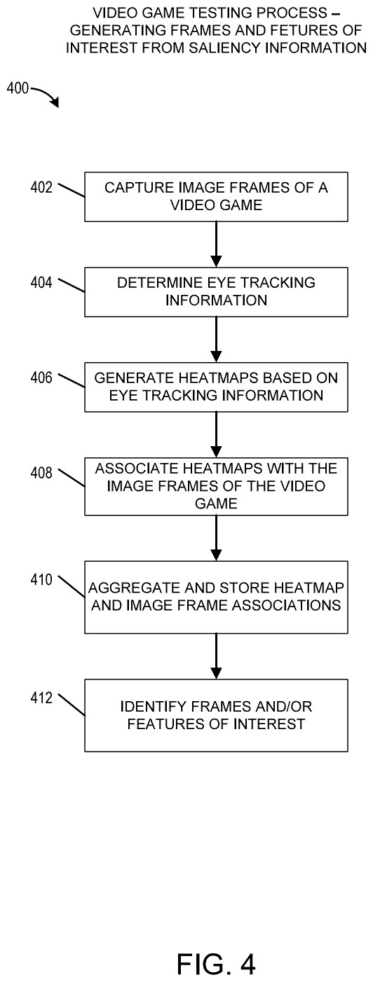

FIG. 4 presents a flowchart of an embodiment of a video game testing process 400 using eye tracking information. The process 400 can be implemented by any system that can execute a video game 112 and receive input from sensors 116. The process 400, in whole or in part, can be implement by, for example, an interactive computing system 130, an image and sensor analysis engine 140, a game test engine 136, a model generation system 146, or a user computing system 110, among others. Although any number of systems, in whole or in part, can implement the process 400, to simplify discussion, the process 400 will be described with respect to particular systems. Further, it should be understood that the process 400 may be updated or performed repeatedly over time. For example, the process 400 may be repeated for each play session of a video game 112, for each round of the video game 112, each week, each month, for every threshold number of play sessions, for a particular testing session of the video game 112, and the like. All or a portion of the process 400 may be performed in real-time, or substantially close to real-time, enabling testing data for the video game 112 to be compiled while the user is playing the video game 112. All or a portion of the process 400 may also be performed after one or more play sessions of the video game 112. For example, testing data for a video game 112 may be analyzed together once a play session has ended.

At block 402, the image and sensor analysis engine 140 captures image frames, such as image frame 202, of a video game 112. The image frames can be images of the video game at a particular instance during runtime. For example, the image frames can be an images generated by the user computing system 110 and/or the interactive computing system 130 that are displayed to a user of the video game 112. Each image frame can have various features, such a virtual objects, textures, colors, shadows, and the like or any combination thereof.

At block 404, the image and sensor analysis engine 140 determines eye tracking information. The eye tracking information can be based on sensor information received from sensors 116. For example, the image and sensor analysis engine 140 can receive an image of user from a camera and determine a coordinate or set of coordinates the user is looking at on a display. The eye tracking information can also include and/or be based on predicted saliency information. For example, the eye tracking information can include the output of one or more models from the model generation system 146 indicating a predicted coordinate or set of coordinates a user would look based on the captured image frames. All or a portion of the predicted saliency information may also be previously generated and retrieved from stored memory (e.g., from the user data repository 148).

At block 406, the image and sensor analysis engine 140 generates heatmaps, such as heatmap 204, from the eye tracking information. The heatmaps may be a coordinate representation of a display associated with eye tracking information. Each coordinate on a heatmap can be associated with a value. Each coordinate value can be based in part on a length of time a user's eye is looking at and/or around the coordinate. Each coordinate value can also be based in part on a probability a user's eye would look at and/or around the coordinate. For example, the coordinate values may be based in part on predicted saliency information in the eye tracking information.

The image and sensor analysis engine 140 may generate the heatmaps using the heatmap generation system 142 based on sensor information and/or predicted saliency information in the eye tracking information. The heatmap generation system 142 can use one or more machine learning models to generate the heatmaps. The heatmap generation system 142 can use the eye tracking information to determine a duration of time the user is looking at a coordinate or set of coordinates to generate the coordinate values of a heatmap 204. In some instances, the heatmap generation system 142 may use one or more models and/or predicted saliency information to filter the eye tracking information.

At block 408, the image and sensor analysis engine 140 associates the heatmaps generated at block 406 with image frames captures at block 402. The heatmaps 204 can include time stamp information relative to the execution of a video game 112. The image and sensor analysis engine 140 can associate heatmaps with image frames using the time stamp information, such as by associating a heatmap with one or more image frames captured in a time frame indicated by the time stamp information. Each heatmap can be associated with a single image frame. Alternatively, each heatmap can be associated with a time including multiple image frames. For example, the heatmap values can be determined based on the eye tracking information for the time frame.

At block 410, the image and sensor analysis engine 140 aggregates and stores heatmap and image frame associations. The data may be representative of a play session and/or testing session of the video game 112. For example, the image and sensor analysis engine 140 can aggregate each heatmap and image frame association collected during the play session and/or testing session of the video game 112 and store the aggregation in a single file. The file can be stored on the interactive computing system 130, such as in the user data repository 148 or game configuration repository 144, on the user computing system 110, and/or on the additional user computing systems 102.

Each heatmap and image frame association can be further associated with information regarding the execution of the video game 112. Such as information regarding the virtual objects, textures, colors, shadows, and the like present in the captured image frames. This information may be helpful to allow other systems, such as the game test engine 136, to analyze results from the heatmap and image frame associations.

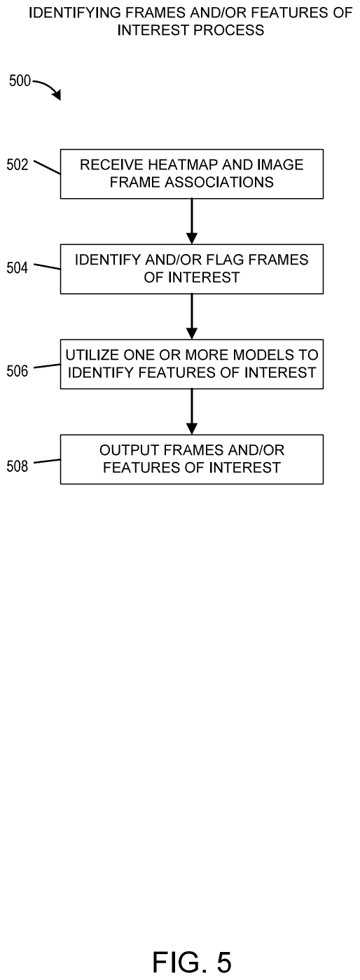

At block 412, the game test engine 136 may identify frames and/or features of interest. As discussed in FIGS. 3A-3C, a heatmap and image frame association, such as image 320, may reveal a frames and features of interest. Frames and/or features of interest may be associated with a goal of a game test. For example, a game test may be executed to find unexpected features that hold user attention, such as image 320. The game test engine 136 may identify the frame as being associated with an unexpected heatmap and/or face 306 as an unexpected feature. Identifying frames and/or features of interest is described in more detail below in FIG. 5.

### Example Process for Identifying Frames/Features of Interest

FIG. 5 presents a flowchart of an embodiment of a video game testing process 500 of identifying frames and/or features of interest based on heatmap and image frame associations. The process 500 can be a subprocess to perform block 412 of the process 400. The process 500 can be implemented by any system that can execute a video game 112 and receive heatmap and image frame associations to test the video game 112. The process 500, in whole or in part, can be implement by, for example, an interactive computing system 130, an image and sensor analysis engine 140, a game test engine 136, a model generation system 146, or a user computing system 110, among others. Although any number of systems, in whole or in part, can implement the process 500, to simplify discussion, the process 500 will be described with respect to particular systems. Further, it should be understood that the process 500 may be updated or performed repeatedly over time. All or a portion of the process 500 may be performed in real-time, or substantially close to real-time, enabling testing data for the video game 112 to be compiled while the user is playing the video game 112. All or a portion of the process 500 may also be performed after one or more play sessions of the video game 112. For example, testing data for a video game 112 may be analyzed together once a play session has ended.

Identifying frames and features of interest can be utilized by the game test engine 136 in many different tests. For example, frames and features of interest can be useful in finding undesirable features, such as a texture error shown in FIGS. 3A-3C. However, the game test engine 136 is not limited to finding undesirable features. For example, the game test engine 136 may identify frames where the user does not look at any particular feature, sets of frames where a user alternates looking at different features, and finding desirable features, to list a few. The game test engine 136 may analyze data from a plurality of gameplay sessions. For example, the game test engine 136 may compare data of different configurations of a video game to test the impact of game configurations (e.g., the game test engine 136 can determine versions of the video game 112 that are more likely to generate responses, such as response associated with a positive or negative user experience). As such, identifying frames and features of interest of heatmap and image frame associations can be useful for many different game testing applications.

At block 502, the game test engine 136 receives heatmap and image frame association information. The heatmap and image frame associations can be generated as discussed at block 410 of FIG. 4.

At block 504, the game test engine 136 identifies and/or flags frames of interest. The game test engine 136 may use one or more machine learning models to determine the frames of interest based on a goal of the particular test. For example, the game test engines 136 may input the data into machine learning models trained to identify frames with unexpected heatmaps. In this example, the machine learning models may compare predicted image saliency based on a captured image with the actual heatmap generated by the captured image, may compare adjacent heatmaps in the data, or otherwise analyze the data. The machine learning models used by the game test engine 136 may differ based on the goal of the particular test. For some testing applications, frames with unexpected heatmaps may be less relevant. For example, a game test may be interested in features that hold user attention for a long period of time. In this example, the game test engine 136 may utilize machine learning model(s) trained to find a set of image frames where the user is consistently looking at the same feature.

At block 506, the game test engine 136 identifies and/or flags features of interest. In some cases, the game test engine 136 may utilize the frames of interest identified and/or flagged at block 504 as a starting point. However, previously identified and/or flagged frames of interest are not necessary. In some instances, the game test engine 136 may perform blocks 502 and 504 concurrently or may perform block 504 prior to block 502.

Similar to block 504, the game test engine 136 may use one or more machine learning models to determine the features of interest based on a goal of the particular test. For example, the game test engines 136 may input the log and/or frames of interest into the machine learning models trained to identify unexpected features, features that hold the user's attention, and/or features the do not hold the user's attention to list a few. As described above, the game test engine 136 may select a machine learning model that is suited for the goal of a particular test.

At block 508, the game test engine 136 outputs the frames and/or features of interest. For example, the frames and/or features of interest may be output to a user, saved, and/or otherwise utilized. In some cases, information regarding the execution of the video game 112, such as information regarding the virtual objects, textures, colors, shadows, and the like, may be output along with the frames and/or features of interest. The information regarding the execution of the video game 112 may be utilized in analyzing the results of a video game test. The game test engine may predictively analyze the frames and/or features of interest. The analysis may identify and/or categorize the frames and/or features using a machine learning model. The categorization may be of a bug, error, anomaly, or other type of defined category. For example, the information may be used to determine a rendering error that triggered an undesirable feature. The output may a be a report that includes the frame and/or features of interest and the reason for the identification.

In some instances, the frames and/or features of interest may automatically cause an action to occur associated with the video game 112. For example, portions of the video game 112, such as a texture package, shader, and/or another portion may be automatically reset.

Example Process for Associating Test Information with Game Configuration

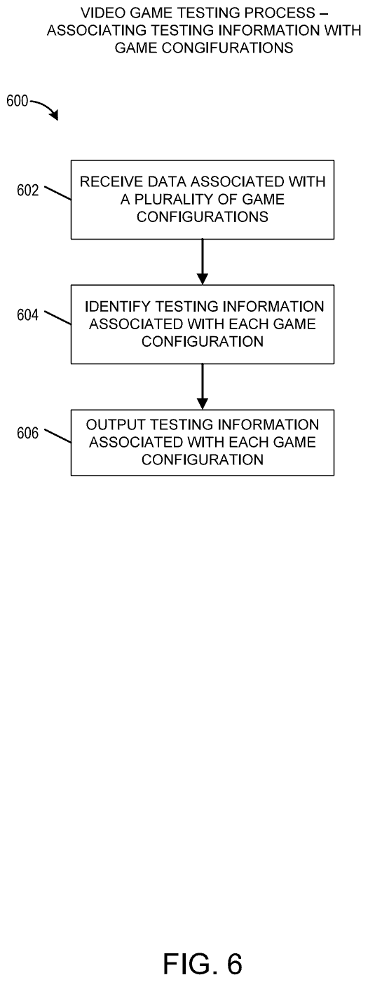

FIG. 6 presents a flowchart of an embodiment of a video game testing process 600 of associating testing information with game configurations. The process 600 can be implemented by any system that can execute a video game 112 and receive logs of heatmap and image frame associations to test the video game 112. The process 600, in whole or in part, can be implement by, for example, an interactive computing system 130, an image and sensor analysis engine 140, a game test engine 136, a model generation system 146, or a user computing system 110, among others. Although any number of systems, in whole or in part, can implement the process 500, to simplify discussion, the process 600 will be described with respect to particular systems. Further, it should be understood that the process 600 may be updated or performed repeatedly over time. All or a portion of the process 600 may be performed in real-time, or substantially close to real-time, enabling testing data for the video game 112 to be compiled while the user is playing the video game 112. All or a portion of the process 600 may also be performed after one or more play sessions of the video game 112. For example, testing data for a video game 112 may be analyzed together once a play session has ended.

The process 600 may be used in testing multiple configurations of a video game 112. The results of the tests for each configuration can be compared to determine attributes of the configuration, such as determining which of multiple configuration is most engaging.

At block 602, the game test engine 136 receives heatmaps and image frames associated with a plurality of game configurations. For example, the game test engine 136 may receive a first set of data associated with configuration A of the video game 112 and a second set of data associated with configuration B of the video game 112. The sets of data may be generated using the process 400.

At block 604, the game test engine 136 determines testing information associated with each game configuration. The testing information can include the frames and features of interest identified through one or more process, such as process 500 along with other information regarding the virtual objects, textures, colors, shadows, and the like associated with the frames and features of interest. For example, the game test system may identify each frame or time frame with features of interest.

At block 606, the game test engine 136 outputs the testing information associated with each game configuration. The testing information can be utilized to compare each game configuration. For example, the testing information for configuration A may indicate that a moving feature in the background held a user's attention. Configuration B may not include the moving feature and the testing information for configuration B may indicate that instead of focusing on the background a feature in the foreground held the user's attention. This difference may be analyzed by a user and/or by the game test engine 136, the game configuration system 134, the interactive computing system 130, or any other component of the networked computing environment 100. For example, in one circumstance the testing information associated with configuration A and configuration B may be analyzed to conclude configuration B was more desirable because the user was less distracted. The game test system can analyze the testing information to automatically identify differences between the configurations. The game test system can output a report that identifies frames and/or time frames for further review by a user. In some embodiments, the game test engine may automatically determine and identify a predicted problem associated with the identified frames/time frames. The output of the testing information associated with each game configuration can provide data for analysis depending on what is being tested.

### Example Process for Analyzing User Position Information

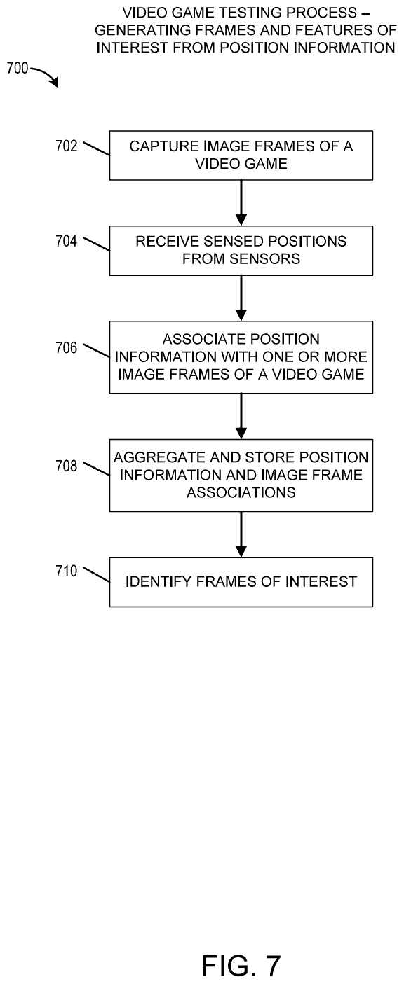

FIG. 7 presents a flowchart of an embodiment of a video game testing process 700 using user position information. The process 700 can be implemented by any system that can execute a video game 112 and receive input from sensors 116 to test the video game 112 based on the sensor 116 input. The process 700, in whole or in part, can be implement by, for example, an interactive computing system 130, an image and sensor analysis engine 140, a game test engine 136, a model generation system 146, or a user computing system 110, among others. Although any number of systems, in whole or in part, can implement the process 700, to simplify discussion, the process 700 will be described with respect to particular systems. Further, it should be understood that the process 700 may be updated or performed repeatedly over time. All or a portion of the process 700 may be performed in real-time, or substantially close to real-time, enabling testing data for the video game 112 to be compiled while the user is playing the video game 112. All or a portion of the process 700 may also be performed after one or more play sessions of the video game 112. For example, testing data for a video game 112 may be analyzed together once a play session has ended.

At block 702, the image and sensor analysis engine 140 captures image frames, such as image frame 202, of a video game 112. The image frames can be images of the video game at a particular instance during runtime. For example, the image frames can be an images generated by the user computing system 110 and/or the interactive computing system 130 that are displayed to a user of the video game 112. Each image frame can have various features, such a virtual objects, textures, colors, shadows, and the like or any combination thereof.

At block 704, the image and sensor analysis engine 140 receives one or more sensed positions of a user of the video game 112 from the sensors 116. As described above, the sensors 116 can include image capturing systems (such as cameras), wearable devices, position detecting systems (such as LIDAR systems), and the like. The sensed positions of the user may include time stamp information of when the each measurement was taken. Each of the sensed positions of the user may be subdivided into portions, such as the position of the user's head, hands, torso, etc.

At block 706, the image and sensor analysis engine 140 associates the sensed positions of the user with image frames captures at block 702. The image and sensor analysis engine 140 can associate sensed positions of the user with image frames using the time stamp information, such as by associating one or more sensed positions of the user with one or more image frames captured in a time frame indicated by the time stamp information. Each sensed position can be associated with a single captured image frame. Alternatively, each sensed position can be associated with multiple captured image frames. For example, the time frame indicated by the time stamp of a sensed position may encompass multiple captured time frames. In this example, the image and sensor analysis engine 140 can associate the sensed position with each captured time frame in the encompassing time frame.

At block 708, the image and sensor analysis engine 140 aggregates and stores sensed positions and image frame associations. The data may be representative of a play session and/or testing session of the video game 112. For example, the image and sensor analysis engine 140 can aggregate each sensed position and image frame association collected during the play session and/or testing session of the video game 112 and store the aggregation in a single file. The data can be stored on the interactive computing system 130, such as in the user data repository 148 or game configuration repository 144, on the user computing system 110, and/or on the additional user computing systems 102.

Each sensed position and image frame association in the log can be further associated with information regarding the execution of the video game 112. Such as information regarding the virtual objects, textures, colors, shadows, and the like present in the captured image frames. This information may be helpful to allow other systems, such as the game test engine 136, to analyze results from the sensed position and image frame associations.

At block 710, the game test engine 136 may identify frames of interest from the log. For example, the game test engine 136 may identify frames where the user gets closer or farther from a screen. As another example, the game test engine 136 may identify frames that cause a sudden movement in the user. In some instances, the log sensed positions and image frame associations may be input into one or more machine learning models to identify frames of interest. The identified frames of interest may also by input into one or more machine learning models to determine features of the frames that may correlate with the sensed user response. The identified frames of interest derived from the process 700 may be alternatively utilized instead of, or along with, the frames of interest discussed in processes, 400, 500, and 600.

### Example Video Game Configuration Processes

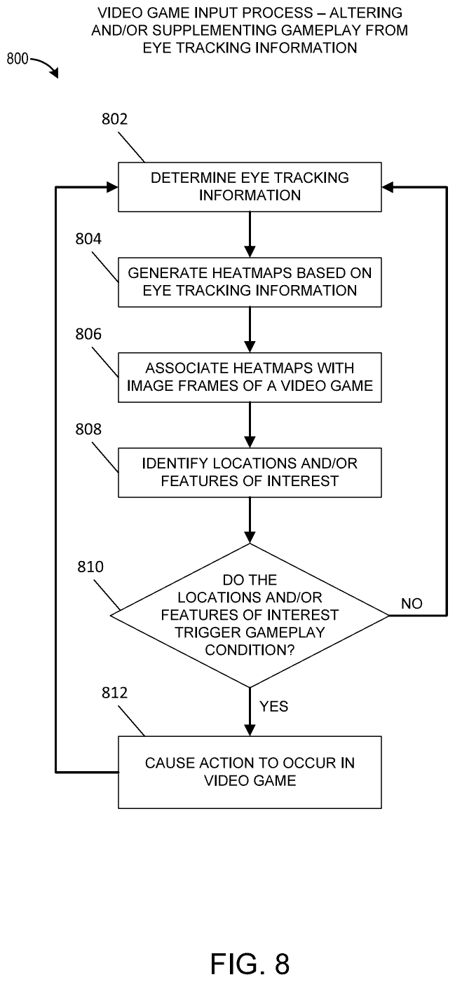

FIG. 8 presents a flowchart of an embodiment of a video game configuration process 800. The process 800 can be implemented by any system that can execute a video game 112 and configure the video game 112 based on input received from sensors 116. The process 800, in whole or in part, can be implement by, for example, an interactive computing system 130, an image and sensor analysis engine 140, game configuration system 134, a model generation system 146, or a user computing system 110, among others. Although any number of systems, in whole or in part, can implement the process 800, to simplify discussion, the process 800 will be described with respect to particular systems. Further, it should be understood that the process 800 may be updated or performed repeatedly over time. All or a portion of the process 800 may be performed in real-time, or substantially close to real-time, enabling configuration and/or reconfiguration of the video game 112 while the user is playing the video game 112.

At block 802, the image and sensor analysis engine 140 determines eye tracking information. The eye tracking information can be based on sensor information received from sensors 116. For example, the image and sensor analysis engine 140 can receive an image of user from a camera and determine a coordinate or set of coordinates the user is looking at on a display.

At block 804, the image and sensor analysis engine 140 generates heatmaps, such as heatmap 204, from the eye tracking information. The heatmaps may be a coordinate representation of a display associated with eye tracking information. Each coordinate on a heatmap can be associated with a value. Each coordinate value can be based in part on a length of time a user's eye is looking at and/or around the coordinate. The heatmap generation system 142 can use the eye tracking information to determine a duration of time the user is looking at a coordinate or set of coordinates to generate the coordinate values of a heatmap 204.

At block 806, the image and sensor analysis engine 140 associates the heatmaps generated at block 804 with image frames captures at block 402. The heatmaps 204 can include time stamp information relative to the execution of a video game 112.

At block 808, the image and sensor analysis engine 140 identifies locations and/or features of interest. The image and sensor analysis engine 140 may utilize some or all of the techniques described in process 400, process 500, process, and/or process 600 to determine features of interest. For example, the image and sensor analysis engine 140 may utilize one or more models, as described at block 506 or process 500, to determine a user of the video game 112 has looked at a location and/or feature for a period of time.

At block 810, the game configuration system 134 determines whether any features of interest trigger a gameplay condition. A gameplay condition may be a predefined set of rules that must be satisfied for a change in game configuration to take effect. Examples of gameplay conditions can include, but are not limited to, a user has looked a location and/or feature for a threshold amount of time, a user has changed a position of eye focus, a user has looked away from a location and/or feature, and/or other changes in a user's eye tracking information, as conveyed through one or more heatmaps. If the game configuration system 134 determines that the locations and/or features of interest trigger a gameplay condition, process 800 proceeds to block 812. Otherwise, process 800 proceeds back to block 802.

At block 812, the game configuration system 134 causes action to occur in the video game 112. Such actions can include, but are not limited to, causing an animation to trigger, causing an audio to play, changing a focal point on the screen, causing an input, triggering an objective or achievement, or adjusting a brightness level, to list a few. The actions may be previously stored in the game configuration repository 144. When the actions include game input, a user's eye tracking information may operate similar to a video game controller. For example, a user may cause the point of view location of the video game 112 to shift using the eye tracking information as the primary input. When the action is complete, process 800 proceeds back to block 802 and can be repeated continuously during a run of the video game 112.

In certain embodiments, operations of the process 800 may be based at least in part on eye tracking and/or positional information. This data may be gathered from a single user or from multiple users. For example, in some cases, a user may play video game 112 with other users in the room who may or may not be playing the video game 112 with the user. In some cases, the game configuration system 134 may filter out eye tracking and/or positional information associated with users who are not playing the video game 112. For example, if the video game 112 is a single player video game, the game configuration system 134 may filter out eye tracking and/or positional information of non-player users. The game configuration system 134 may identify the eye tracking and/or positional information that is associated with non-player users based at least in part on the information received from 116. For example, based on images captured by the sensors 116, the game configuration system 134 may determine users in a room that are not playing the video game 112 and may filter out any eye tracking and/or positional information obtained from such users.

### Overview of Computing System

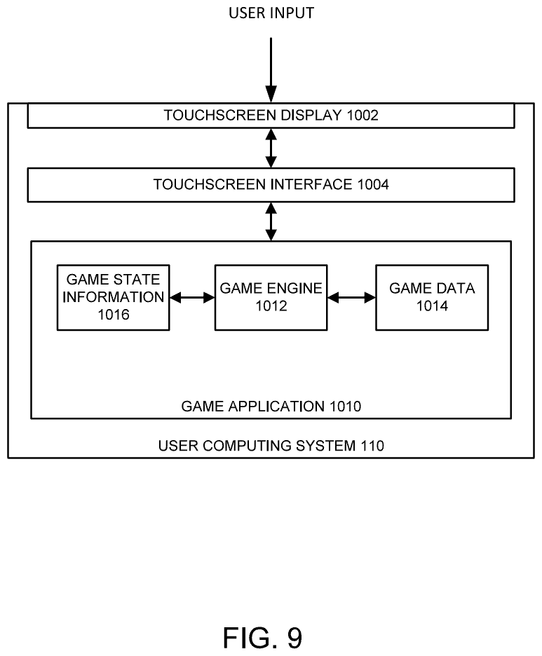

FIG. 9 illustrates an embodiment of a user computing system 110, which may also be referred to as a gaming system. As illustrated, the user computing system 110 may be a single computing device that can include a number of elements. However, in some cases, the user computing system 110 may include multiple devices. For example, the user computing system 110 may include one device that includes that includes a central processing unit and a graphics processing unit, another device that includes a display, and another device that includes an input mechanism, such as a keyboard or mouse.

The user computing system 110 can be an embodiment of a computing system that can execute a game system. In the non-limiting example of FIG. 10, the user computing system 110 is a touch-capable computing device capable of receiving input from a user via a touchscreen display 1002. However, the user computing system 110 is not limited as such and may include non-touch capable embodiments, which do not include a touchscreen display 1002.

The user computing system 110 includes a touchscreen display 1002 and a touchscreen interface 1004, and is configured to execute a game application 1010. This game application may be the video game 112 or an application that executes in conjunction with or in support of the video game 112, such as a video game execution environment. Although described as a game application 1010, in some embodiments the application 1010 may be another type of application that may have a variable execution state based at least in part on the preferences or capabilities of a user, such as educational software. While user computing system 110 includes the touchscreen display 1002, it is recognized that a variety of input devices may be used in addition to or in place of the touchscreen display 1002.

The user computing system 110 can include one or more processors, such as central processing units (CPUs), graphics processing units (GPUs), and accelerated processing units (APUs). Further, the user computing system 110 may include one or more data storage elements. In some embodiments, the user computing system 110 can be a specialized computing device created for the purpose of executing game applications 1010. For example, the user computing system 110 may be a video game console. The game applications 1010 executed by the user computing system 110 may be created using a particular application programming interface (API) or compiled into a particular instruction set that may be specific to the user computing system 110. In some embodiments, the user computing system 110 may be a general purpose computing device capable of executing game applications 1010 and non-game applications. For example, the user computing system 110 may be a laptop with an integrated touchscreen display or desktop computer with an external touchscreen display. Components of an example embodiment of a user computing system 110 are described in more detail with respect to FIG. 11.

The touchscreen display 1002 can be a capacitive touchscreen, a resistive touchscreen, a surface acoustic wave touchscreen, or other type of touchscreen technology that is configured to receive tactile inputs, also referred to as touch inputs, from a user. For example, the touch inputs can be received via a finger touching the screen, multiple fingers touching the screen, a stylus, or other stimuli that can be used to register a touch input on the touchscreen display 1002. The touchscreen interface 604 can be configured to translate the touch input into data and output the data such that it can be interpreted by components of the user computing system 110, such as an operating system and the game application 1010. The touchscreen interface 1004 can translate characteristics of the tactile touch input touch into touch input data. Some example characteristics of a touch input can include, shape, size, pressure, location, direction, momentum, duration, and/or other characteristics. The touchscreen interface 1004 can be configured to determine the type of touch input, such as, for example a tap (for example, touch and release at a single location) or a swipe (for example, movement through a plurality of locations on touchscreen in a single touch input). The touchscreen interface 1004 can be configured to detect and output touch input data associated with multiple touch inputs occurring simultaneously or substantially in parallel. In some cases, the simultaneous touch inputs may include instances where a user maintains a first touch on the touchscreen display 1002 while subsequently performing a second touch on the touchscreen display 1002. The touchscreen interface 1004 can be configured to detect movement of the touch inputs. The touch input data can be transmitted to components of the user computing system 110 for processing. For example, the touch input data can be transmitted directly to the game application 1010 for processing.

In some embodiments, the touch input data can undergo processing and/or filtering by the touchscreen interface 1004, an operating system, or other components prior to being output to the game application 1010. As one example, raw touch input data can be captured from a touch input. The raw data can be filtered to remove background noise, pressure values associated with the input can be measured, and location coordinates associated with the touch input can be calculated. The type of touch input data provided to the game application 1010 can be dependent upon the specific implementation of the touchscreen interface 1004 and the particular API associated with the touchscreen interface 1004. In some embodiments, the touch input data can include location coordinates of the touch input. The touch signal data can be output at a defined frequency. Processing the touch inputs can be computed many times per second and the touch input data can be output to the game application for further processing.

A game application 1010 can be configured to be executed on the user computing system 110. The game application 1010 may also be referred to as a video game, a game, game code and/or a game program. A game application should be understood to include software code that a user computing system 110 can use to provide a game for a user to play. A game application 1010 might comprise software code that informs a user computing system 110 of processor instructions to execute, but might also include data used in the playing of the game, such as data relating to constants, images and other data structures. For example, in the illustrated embodiment, the game application includes a game engine 1012, game data 1014, and game state information 1016.

The touchscreen interface 1004 or another component of the user computing system 110, such as the operating system, can provide user input, such as touch inputs, to the game application 1010. In some embodiments, the user computing system 110 may include alternative or additional user input devices, such as a mouse, a keyboard, a camera, a game controller, and the like. A user can interact with the game application 1010 via the touchscreen interface 1004 and/or one or more of the alternative or additional user input devices. The game engine 1012 can be configured to execute aspects of the operation of the game application 1010 within the user computing system 110. Execution of aspects of gameplay within a game application can be based, at least in part, on the user input received, the game data 1014, and game state information 1016. The game data 1014 can include game rules, prerecorded motion capture poses/paths, environmental settings, constraints, animation reference curves, skeleton models, and/or other game application information. Further, the game data 1014 may include information that is used to set or adjust the difficulty of the game application 1010.

The game engine 1012 can execute gameplay within the game according to the game rules. Some examples of game rules can include rules for scoring, possible inputs, actions/events, movement in response to inputs, and the like. Other components can control what inputs are accepted and how the game progresses, and other aspects of gameplay. During execution of the game application 1010, the game application 1010 can store game state information 1016, which can include character states, environment states, scene object storage, and/or other information associated with a state of execution of the game application 1010. For example, the game state information 1016 can identify the state of the game application at a specific point in time, such as a character position, character action, game level attributes, and other information contributing to a state of the game application.

The game engine 1012 can receive the user inputs and determine in-game events, such as actions, collisions, runs, throws, attacks and other events appropriate for the game application 1010. During operation, the game engine 1012 can read in game data 1014 and game state information 1016 in order to determine the appropriate in-game events. In one example, after the game engine 1012 determines the character events, the character events can be conveyed to a movement engine that can determine the appropriate motions the characters should make in response to the events and passes those motions on to an animation engine. The animation engine can determine new poses for the characters and provide the new poses to a skinning and rendering engine. The skinning and rendering engine, in turn, can provide character images to an object combiner in order to combine animate, inanimate, and background objects into a full scene. The full scene can be conveyed to a renderer, which can generate a new frame for display to the user. The process can be repeated for rendering each frame during execution of the game application. Though the process has been described in the context of a character, the process can be applied to any process for processing events and rendering the output for display to a user.

### Example Hardware Configuration of Computing System

FIG. 10 illustrates an embodiment of a hardware configuration for the user computing system 110 of FIG. 10. Other variations of the user computing system 110 may be substituted for the examples explicitly presented herein, such as removing or adding components to the user computing system 110. The user computing system 110 may include a dedicated game device, a smart phone, a tablet, a personal computer, a desktop, a laptop, a smart television, a car console display, and the like. Further, (although not explicitly illustrated in FIG. 11) as described with respect to FIG. 10, the user computing system 110 may optionally include a touchscreen display 1002 and a touchscreen interface 1004.

As shown, the user computing system 110 includes a processing unit 20 that interacts with other components of the user computing system 110 and also components external to the user computing system 110. A game media reader 22 may be included that can communicate with game media 12. Game media reader 22 may be an optical disc reader capable of reading optical discs, such as CD-ROM or DVDs, or any other type of reader that can receive and read data from game media 12. In some embodiments, the game media reader 22 may be optional or omitted. For example, game content or applications may be accessed over a network via the network I/O 38 rendering the game media reader 22 and/or the game media 12 optional.

The user computing system 110 may include a separate graphics processor 24. In some cases, the graphics processor 24 may be built into the processing unit 20, such as with an APU. In some such cases, the graphics processor 24 may share Random Access Memory (RAM) with the processing unit 20. Alternatively, or in addition, the user computing system 110 may include a discrete graphics processor 24 that is separate from the processing unit 20. In some such cases, the graphics processor 24 may have separate RAM from the processing unit 20. Further, in some cases, the graphics processor 24 may work in conjunction with one or more additional graphics processors and/or with an embedded or non-discrete graphics processing unit, which may be embedded into a motherboard and which is sometimes referred to as an on-board graphics chip or device.

The user computing system 110 also includes various components for enabling input/output, such as an I/O 32, a user I/O 34, a display I/O 36, and a network I/O 38. As previously described, the input/output components may, in some cases, including touch-enabled devices. The I/O 32 interacts with storage element 40 and, through a device 42, removable storage media 44 in order to provide storage for the user computing system 110. Processing unit 20 can communicate through I/O 32 to store data, such as game state data and any shared data files. In addition to storage 40 and removable storage media 44, user computing system 110 is also shown including ROM (Read-Only Memory) 46 and RAM 48. RAM 48 may be used for data that is accessed frequently, such as when a game is being played.

User I/O 34 is used to send and receive commands between processing unit 20 and user devices, such as game controllers. In some embodiments, the user I/O 34 can include touchscreen inputs. As previously described, the touchscreen can be a capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game, such as when a game is being played online or being accessed online.

Display output signals may be produced by the display I/O 36 and can include signals for displaying visual content produced by the user computing system 110 on a display device, such as graphics, user interfaces, video, and/or other visual content. The user computing system 110 may comprise one or more integrated displays configured to receive display output signals produced by the display I/O 36, which may be output for display to a user. According to some embodiments, display output signals produced by the display I/O 36 may also be output to one or more display devices external to the user computing system 110.

The user computing system 110 can also include other features that may be used with a game, such as a clock 50, flash memory 52, and other components. An audio/video player 56 might also be used to play a video sequence, such as a movie. It should be understood that other components may be provided in the user computing system 110 and that a person skilled in the art will appreciate other variations of the user computing system 110.

Program code can be stored in ROM 46, RAM 48, or storage 40 (which might comprise hard disk, other magnetic storage, optical storage, solid state drives, and/or other non-volatile storage, or a combination or variation of these). At least part of the program code can be stored in ROM that is programmable (ROM, PROM, EPROM, EEPROM, and so forth), in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the play of the game and portions thereof might also be reserved for frame buffers, game state and/or other data needed or usable for interpreting user input and generating game displays. Generally, RAM 48 is volatile storage and data stored within RAM 48 may be lost when the user computing system 110 is turned off or loses power.

As user computing system 110 reads game media 12 and provides a game, information may be read from game media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as game media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A computer-implemented method comprising:
as implemented by an interactive computing system configured with specific computer-executable instructions,
capturing one or more image frames of a video game;
receiving, from one or more sensors, eye tracking information associated with a user playing the video game;
associating the eye tracking information with the one or more image frames;
identifying at least a first frame based at least in part on the eye tracking information;
identifying at least one feature of interest within the first frame based on the eye tracking information; and
outputting an indication associated with the at least one feature of interest.

2. The computer-implemented method of claim 1, wherein the indication is a category associated the at least one feature of interest.

3. The computer-implemented method of claim 2, wherein the category is a rendering error for an improperly rendered or an unrendered feature.

4. The computer-implemented method of claim 1, wherein the one or more sensors comprise a camera.

5. The computer-implemented method of claim 1, wherein the sensor information comprises positional information associated with the user.

6. The computer-implemented method of claim 5, wherein the one or more sensors comprise a light detection and ranging (“LIDAR”) system.

7. The computer-implemented method of claim 2, wherein associating the sensor information with the one or more image frames comprises:
generating at least a first heatmap based on the eye tracking information using one or more machine learning models trained to generate heatmaps from the eye tracking information; and
associating the first heatmap with the one or more image frames.

8. The computer-implemented method of claim 7, wherein the first heatmap identifies eye position of the user with respect to image frames over a defined time frame.

9. The computer-implemented method of claim 1, further comprising altering a configuration of the video game based on the at least one feature of interest.

10. The computer-implemented method of claim 9, wherein altering the configuration of the video game comprises:
determining the first feature of interest triggers a condition; and
causing one or more actions to occur in the video game based on the condition.

11. The computer-implemented method of claim 10, wherein the one or more actions comprise an animation triggered within a virtual environment of the video game.

12. A system comprising:
one or more sensors; and
one or more hardware processor in communication with the one or more sensors, the one or more hardware processors configured to execute specific computer-executable instructions to at least:
capture one or more image frames of a video game;
receive, from the one or more sensors, eye tracking information associated with a user playing the video game;
associate the sensor information with the one or more image frames;
identify at least a first frame based at least in part on the eye tracking information;
identify at least one feature of interest within the first frame based on the eye tracking information; and
output an indication associated with the at least one feature of interest.

13. The system of claim 12, wherein the indication is a category associated the at least one feature of interest.

14. The system of claim 13, wherein the category is a rendering error for an improperly rendered or an unrendered feature.

15. The system of claim 12, wherein the one or more sensors comprise a camera.

16. The system of claim 12, wherein the one or more sensors comprise a light detection and ranging (“LIDAR”) system.

17. The system of claim 13, wherein to associate the sensor information with the one or more image frames, the one or more hardware processors are configured to execute the specific computer-executable instructions to:
generate at least a first heatmap based on the eye tracking information using one or more machine learning models trained to generate heatmaps from the eye tracking information; and
associate the first heatmap with the one or more image frames.

18. The system of claim 17, wherein the first heatmap identifies eye position of the user with respect to image frames over a defined time frame.

19. The system of claim 12, wherein the one or more hardware processors are further configured to execute the specific computer-executable instructions to alter a configuration of the video game based on the first frame of interest.

20. A non-transitory computer-readable storage medium storing computer executable instructions that, when executed by one or more computing devices, configure the one or more computing devices to perform operations comprising:
as implemented by an interactive computing system configured with specific computer-executable instructions,
capturing one or more image frames of a video game;
receiving, from one or more sensors, eye tracking information associated with a user playing the video game;
associating the eye tracking information with the one or more image frames;
identifying at least a first frame based at least in part on the eye tracking information;
identifying at least one feature of interest within the first frame based on the eye tracking information; and
outputting an indication associated with the at least one feature of interest.
